(19) United States
(12) Patent Application Publication
(10) Pub. No.: US 2019/0233251 A1
(43) Pub. Date: Aug. 1, 2019

(54) METHOD AND AN ELEVATOR CONTROL UNIT FOR CONTROLLING A DOORSTEP GAP OF AN ELEVATOR AND AN ELEVATOR

(71) Applicant: Kone Corporation, Helsinki (FI)

(72) Inventors: Tero Hakala, Helsinki (FI); Ari Kattainen, Helsinki (FI); Jussi Lahteenmaki, Helsinki (FI); Seppo Suur-Askola, Helsinki (FI); Jussi Perala, Helsinki (FI)

(73) Assignee: Kone Corporation, Helsinki (FI)

(21) Appl. No.: 16/234,981

(22) Filed: Dec. 28, 2018

(30) Foreign Application Priority Data
Jan. 30, 2018 (EP) 18154092.3

(51) Int. Cl. B66B 1/30; B66B 13/26

(52) U.S. Cl. CPC B66B 1/30; B66B 5/00; B66B 13/26

(57) ABSTRACT

A method and an elevator control unit for controlling a doorstep gap at a landing floor of an elevator and an elevator are presented. The elevator comprising an electric linear motor coupled to an elevator car, wherein the method comprises moving the elevator car relative to a stator beam of the electric linear motor at the landing floor for controlling the doorstep gap at the landing floor.

This application claims priority to European Patent Application No. 18154092.3 filed on Jan. 30, 2018, the entire contents of which are incorporated herein by reference.

### TECHNICAL FIELD

The invention concerns in general the technical field of elevators. The invention concerns especially, however, not exclusively, elevators comprising electric linear motors, and controlling the moving of an elevator car of such an elevator at a landing floor.

### BACKGROUND

The elevator car of a conventional elevator is configured to be moved within the elevator shaft or hoist-way by means of a hoisting rope attached to the elevator car. The hoisting rope is furthermore in connection to a hoisting motor which may be arranged, for example, to the top part of the elevator shaft.

At the present time, the elevators utilizing electric linear motors are being developed. The movement of the elevator car can be produced by the mover or movers in connection with the stator of the electric linear motor. The stator is being arranged in fixed manner with respect to the environment, that is, the elevator shaft.

The use of electric linear motors in elevators facilitate designing elevators having elevator cars moving in addition to vertical directions, that is, up and down, also to horizontal directions and to any other direction as well, depending basically on the direction into which the stator of the electric linear motor has been arranged.

In conventional elevators having a hoisting rope and an elevator car configured to move only in vertical directions, the elevator car tends to move in horizontal direction to some extent and, therefore, there must be sufficient gap between the elevator car and surrounding structures, such as, the walls of the elevator shaft. There is thus typically a doorstep gap between the elevator car and the landing floor, or, for example, between the sills thereof, when the elevator car is at the landing floor, which may be so large that there is a risk of stumbling for people entering and leaving the elevator car. However, in modern elevators utilizing electric linear motors, the tolerances can be made smaller because the elevator car does not move as much in the horizontal directions. However, the doorstep gap may still be significant as the elevator car cannot be very close to or in contact with the landing floor due to the apparent reason that the elevator car should be able to move in the elevator shaft smoothly without touching any surrounding structures which can lead to noise and damaging of the equipment.

Thus, there is still a need to develop elevators in which the doorstep gap can be made smaller when the elevator car is at the landing floor.

### SUMMARY

An objective of the present invention is to provide a method, an elevator control unit, a computer program product and an elevator for controlling a doorstep gap at a landing floor of the elevator. Another objective of the present invention is that the method, the elevator control unit, the computer program product and the elevator reduces the doorstep gap when the elevator car is at the landing floor, thus reducing the risk of stumbling for people.

The objectives of the invention are reached by a method, an elevator control unit, a computer program product and an elevator as defined by the respective independent claims.

According to a first aspect, a method for controlling a doorstep gap at a landing floor of an elevator is provided. The elevator comprises an electric linear motor coupled to an elevator car. The method comprises moving the elevator car relative to a stator beam of the electric linear motor at the landing floor for controlling the doorstep gap at the landing floor.

Furthermore, the moving may comprise controlling magnetic levitation of the electric linear motor at the landing floor for moving the elevator car at least towards or away from the landing floor.

The method may comprise controlling the moving of the elevator car at least towards or away from the landing floor by utilizing an electromagnetic component of the electric linear motor.

The electric linear motor may comprise a mover in electromagnetic engagement with a stator comprised in the stator beam. The mover may be coupled to the elevator car. In the method the controlling of said magnetic levitation may comprise controlling a current at least partly establishing said electromagnetic engagement.

The moving may, alternatively or in addition, comprise utilizing displacement means configured for moving the elevator car at least towards or away from the landing floor at the landing floor.

The displacement means may be coupled to the elevator car and configured for moving the elevator car at least towards or away from the landing floor.

The displacement means may comprise an active damper coupled to the mover and configured for moving the elevator car relative to the mover at least towards or away from the landing floor.

The displacement means may be coupled to the elevator shaft at least at the landing floor and configured for moving the elevator car at least towards or away from the landing floor.

The method may further comprise limiting the moving of the elevator car towards the landing floor by limiting means for limiting the movement of the elevator car. Alternatively or in addition, the method may comprise limiting the moving of the elevator car towards the landing floor by a guiding rail.

The method may comprise opposing the moving of the elevator car towards the landing floor by an elastic element.

The method may comprise receiving the elevator car at the landing floor.

According to a second aspect, an elevator control unit for controlling a doorstep gap at a landing floor of an elevator is provided. The elevator comprises an electric linear motor coupled to an elevator car. The elevator control unit comprises: at least one processor and at least one memory storing at least one portion of computer program code. The at least one processor is configured to cause the elevator control unit at least to perform: move the elevator car relative to a stator beam of the electric linear motor at the landing floor for controlling the doorstep gap at the landing floor.

According to a third aspect, a computer program product comprising program instructions which when executed by an elevator control unit cause the elevator control unit to perform the method according to the first aspect is provided.

According to a fourth aspect, an elevator for controlling a doorstep gap at a landing floor of an elevator is provided. The elevator comprises an electric linear motor coupled to an elevator car. The elevator further comprises an elevator control unit configured to at least: move the elevator car relative to a stator beam of the electric linear motor at the landing floor for controlling the doorstep gap at the landing floor. The elevator control unit and the electric linear motor are coupled to each other.

The present invention provides a method, an elevator control unit, a computer program product and an elevator for controlling a doorstep gap at a landing floor of the elevator. The method provides advantages over known solutions such that the doorstep gap can be made smaller, thus reducing the risk of people stumbling when entering or leaving the elevator car, without the elevator car moving too close to or in contact with the surrounding structures of the elevator shaft when being moved along the elevator shaft. Furthermore, the elevator car can be made to move sufficiently far from the surrounding structures of the elevator shaft notwithstanding the advantageously narrow doorstep gap at the landing floor.

Various other advantages will become clear to a skilled person based on the following detailed description.

The expression “a plurality of” refers herein to any positive integer starting from two, e.g. to two, three, or four.

The terms “first”, “second”, “third”, and “fourth” do not denote any order, quantity, or importance, but rather are used to distinguish one element from another.

The exemplary embodiments of the present invention presented herein are not to be interpreted to pose limitations to the applicability of the appended claims. The verb “to comprise” is used herein as an open limitation that does not exclude the existence of also un-recited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

The embodiments of the present invention are illustrated by way of example and not by way of limitation in the figures of the accompanying drawings.

FIG. 1 illustrates schematically an elevator according to an embodiment of the present invention by a cross-sectional side view.

FIG. 2 illustrates highly schematically an arrangement for controlling a doorstep gap at a landing floor of the elevator according to an embodiment of the present invention.

FIG. 3 illustrates schematically an arrangement for controlling a doorstep gap at a landing floor of the elevator according to an embodiment of the present invention.

FIG. 4 illustrates schematically an arrangement for controlling a doorstep gap at a landing floor of the elevator according to another embodiment of the present invention.

FIG. 5 illustrates schematically an arrangement for controlling a doorstep gap at a landing floor of the elevator according to another embodiment of the present invention.

FIG. 6 illustrates schematically an arrangement for controlling a doorstep gap at a landing floor of the elevator according to another embodiment of the present invention.

FIGS. 7A and 7B illustrate schematically the moving of the elevator car towards the landing floor by according to an embodiment of the present invention.

FIG. 8 illustrates schematically an arrangement for controlling a doorstep gap at a landing floor of the elevator according to an embodiment of the present invention.

FIG. 9 illustrates schematically an arrangement for controlling a doorstep gap at a landing floor of the elevator according to an embodiment of the present invention.

FIG. 10 illustrates schematically an arrangement for controlling a doorstep gap at a landing floor of the elevator according to an embodiment of the present invention.

FIG. 11 illustrates a flow diagram of the method according to an embodiment of the present invention.

FIG. 12 illustrates schematically an elevator control unit according to an embodiment of the present invention.

### DESCRIPTION OF SOME EMBODIMENTS

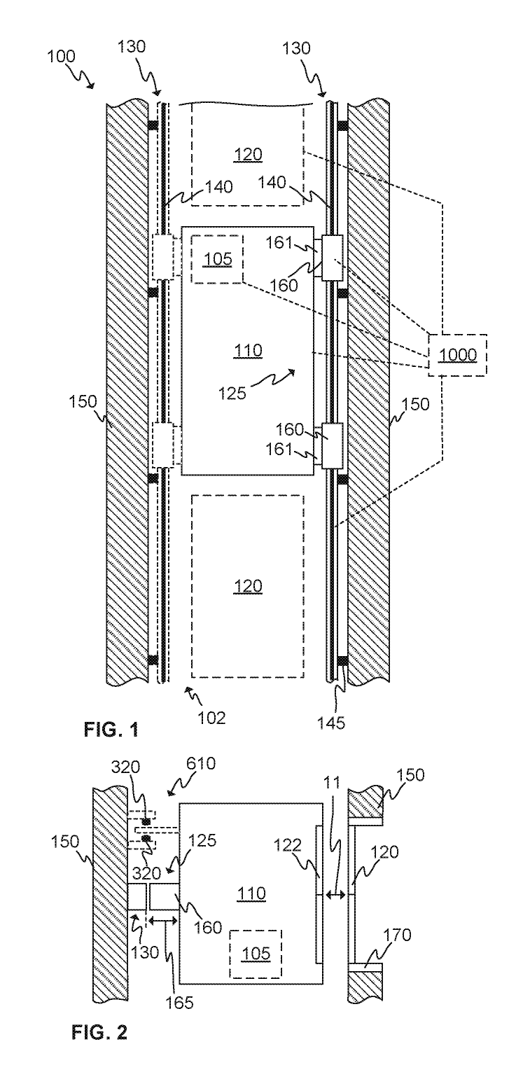

FIG. 1 illustrates schematically an elevator 100 according to an embodiment of the present invention by a cross-sectional side view. The elevator 100 may comprise an elevator shaft 102 and an electric linear motor 125 coupled to the elevator car 110. The electric linear motor 125 is configured to move the elevator car 110 in the elevator shaft 102. The elevator 100 may comprise, preferably, at least two landing floors comprising landing doors 120 and/or openings 120.

The elevator car 110 may, preferably, be designed to serve the landing floors during normal operation of the elevator 100. The moving of the elevator car 110 may normally be upwards and downwards. However, the electric linear motor 125 may also be arranged to move the elevator car 110 in horizontal directions or in any other directions. This may be achieved by arranging a stator beam 130 or beams 130 to align relative to the desired direction. The stator beam 130 may comprise a stator 140 or stators 140 or may essentially be the stator 140 of the electric linear motor 125 or may, preferably, comprise support structures into which the stator 140 or stators 140 have been attached to.

The stator beam 130 or beams 130 may preferably be arranged in fixed manner with respect to the environment, that is, with respect to the elevator shaft 102 as shown in FIG. 1. The stator beam 130 or beams 130 may be mounted to a wall 150 or walls 150 of the elevator shaft 102 by fastening element(s) 145.

The elevator car 110 may be mechanically mounted or coupled to a mover 160 or movers 160 of the linear electric motor 125 directly or, for example, by at least via one mover support member 161. As can be seen in FIG. 1, there may be two movers 160 arranged to be moved, and thus also move the elevator car 110, along one stator beam 130, that is, in the longitudinal direction of the stator beam 130. However, there may be one mover 160 or more than two movers 160 arranged to be moved along one stator beam 130. One or two or more of them may be mechanically coupled to one elevator car 110. There may also be one or a plurality of stator beams 130, preferably, arranged stationary with respect to the environment, that is, in this case the elevator shaft 102, in which the electric linear motor 125 is intended to move the elevator car 110.

The mover 160 or movers 160 are configured to be in electromagnetic engagement with the stator 140 or stators 140 of the electric linear motor 125 for moving the mover 160 or movers 160 along the stator 140 or stators 140. The electromagnetic engagement may be implemented by controllable electromagnetic components, such as windings or coils, arranged to the mover 160 and/or to the stator 140. Furthermore, the mover 160 and/or the stator 140 may comprise permanent magnets and/or irons made of ferromagnetic material for providing proper magnetic circuits suitable for electric motor operation.

The elevator 100 may furthermore comprise means for controlling the operation of the elevator 100. These may include an elevator control unit 1000 which may be communicatively connected to various components of the elevator 100, for example, to elevator car 110, the electrical drive 105, landing doors 120, stator beam 130, stator 140, mover 160, etc.

The electrical drive 105 may be configured for driving or controlling the operation of the electric linear motor 125. The electrical drive 105 may, preferably, be arranged to the elevator car 110 for injecting current into the electromagnetic components of the mover 160. However, according to some embodiments, the electrical drive 105 may instead be arranged to the elevator shaft 102 for injecting current into the electromagnetic components of the stator 140 or stators 140, for instance, depending on the topology and characteristics of the electric linear motor 125. There may also be an electrical energy storage arranged to the elevator car 110 for providing electrical power to operate the appliances and equipment in the elevator car 110 as well as, in some embodiments, to move the mover 160, and thus the elevator car 110, along the stator 140 of the stator beam 130.

The electric linear motor 125 may, preferably, be configured to magnetically levitate the mover 160 with respect to stator 140 or the stator beam 130, that is, to comprise an air gap between the mover(s) 160 and the stator(s) 140 at least during the moving of the mover 160 with respect to the stator beam 130. The magnetic levitation, that is, primarily the levitation or movement of the mover 160 in a direction perpendicular with respect to the longitudinal direction of the stator beam 130, may be controlled by the injecting and controlling the current to the electromagnetic components of the mover(s) 160 or the stator(s) 140. This may be done by the electrical drive 105, for instance. According to another embodiment of the present invention, the electric linear motor 125 is utilized only for producing movement of the mover 160 along the longitudinal direction of the stator beam 130, that is, the lateral movement (in said perpendicular directions) is not controlled by the electric linear motor 125. The elevator 100 may be comprise a guide rail, such as comprising rollers or sliding surfaces, for controlling the lateral movement.

According to some embodiments, the elevator 100 may further comprise a counterweight coupled to the elevator car 110 by a rope in addition to other required components such as a sheave.

FIG. 2 illustrates highly schematically an arrangement for controlling a doorstep gap 11 at a landing floor of the elevator 100 according to an embodiment of the present invention. The elevator 100 comprises an electric linear motor 125 which comprises a mover 160 and a stator comprised in the stator beam 130. The stator beam 130 may be attached fixedly to the wall 150 of the elevator shaft 102. The elevator car 110 is considered to be at a landing floor when the doors 122 of the car 110 are substantially at the corresponding position with respect to the landing doors 120 or opening 120 for people, if any, to enter or leave the elevator car 110. There may also be additional support structures 170, such as a frame 170, at the landing floor.

In FIG. 2, the mover 160 of the electric linear motor 125 is coupled to the elevator car 110 and is configured to be in electromagnetic engagement with the stator 140 of the electric linear motor 125. The electromagnetic engagement may be implemented by permanent magnets and/or controllable electromagnetic components, such as, windings. The characteristics of the electromagnetic engagement may be controlled or changed, at least partly, by controlling the current injected to the windings, for example, by the electrical drive 105. The electromagnetic engagement enables at least moving the elevator car 110 along to stator 140 attached and extending along the stator beam 130 and, optionally, also magnetically levitating the mover 160 relative to the stator 140. The magnetic levitation is provided by means of the electromagnetic engagement between the mover 160 and the stator 140, the characteristics of which may be controlled as stated hereinabove.

The magnitude of the gap 11 between the landing floor, or the sill thereof, and the elevator car 110 may, preferably, be controlled by controlling the distance 165 between the stator beam 130 and the elevator car 110 or at least moving the elevator car 110 relative to the stator beam 130. According to some embodiments, as will be described hereinlater with respect to FIG. 4, the elevator car 110 may be moved relative to the stator beam 130 in a direction perpendicular with respect to the distance 165 between the stator beam 130 and the elevator car 110.

There may also be a guiding rail 610 for guiding the moving of the elevator car 110. The guide rail 610 may be separate from the stator beam 130 or beams 130, and may comprise guiding elements 320, such as, rollers 320 or sliding surfaces, for instance. The guiding rail 610 may extend continuously through whole elevator shaft 102 or may be arranged only at the landing floors for limiting or restricting or at least opposing the moving of the elevator car 110 during magnetic levitation and moving towards and/or away from the landing floor. The guiding rail 610 may be arranged to guide the moving of the elevator car 110 along the stator beam 130, especially, in embodiments where the magnetic levitation of the electric linear motor 125 is not being controlled. The guide rail 610 may be arranged to prevent the elevator car 110 from coming in contact with the landing floor or the sill thereof. It may, however, be arranged to limit the moving in other directions as well. The guide rail 610 may preferably comprise a first guiding element attached to the elevator shaft 102 and a second guiding element attached to the elevator car 110. There may, preferably, be specific flanges or contact surfaces, or means of abutting, arranged to the guiding rail 610 for coming into contact with one another for limiting the motion of the elevator car 110. Furthermore, the guide rail 610 may comprise, for example, an elastic elements, such as a spring element, coupled to a roller or to the means of abutting so that the elastic element opposes the movement of the elevator car 110 against or away from the landing floor or the sill thereof. The elastic element may be coupled to the elevator shaft 102 or the elevator car 110. Although the guide rail 610 has been shown to be arranged between the back wall of the elevator car 110 and the elevator shaft 102, the guide rail 610 may as well be arranged to the sides of the elevator car 110 or at the same side as the landing doors 120 or the opening 120.

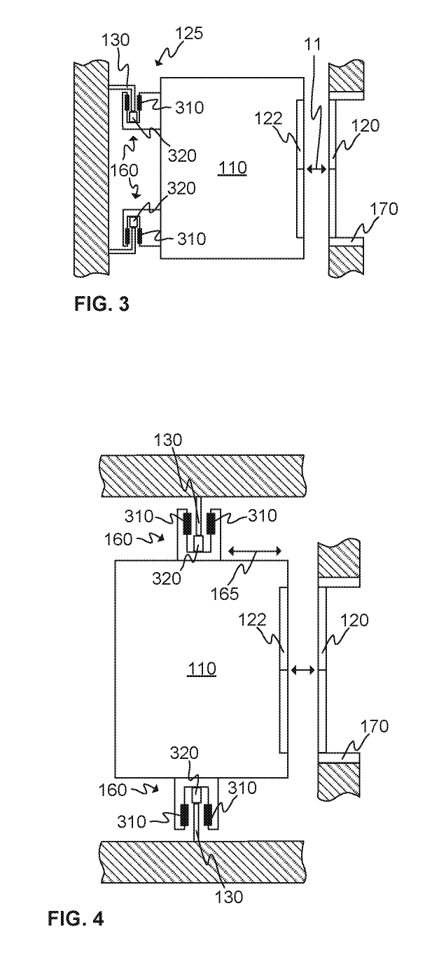

FIG. 3 illustrates schematically an arrangement for controlling a doorstep gap 11 at a landing floor of the elevator 100 according to an embodiment of the present invention. In order to move the elevator car 110 in the elevator shaft 102 there must be a certain distance, or a gap, between the elevator car 110 and the surrounding structures. At a landing floor, however, the doorstep gap 11 should be as short as possible in order to avoid people stumbling when leaving or entering the elevator car 110. The current injected to the electromagnetic components 310 of the electric linear motor 125 for moving the mover 160 relative to the stator 140, so that the elevator car 110 moves towards the landing floor, may be controlled such that the mover 160 moves towards the landing floor while being magnetically levitated, that is, by controlling the magnetic levitation. The doorstep gap 11 may in some cases be completely closed, that is, the sill of the elevator car 110 comes into contact with the sill of the landing floor.

In FIG. 3, there are two parallel, L-shaped stator beams 130 arranged to a wall 150 or support structure, in this case the back wall 150, of the elevator shaft 102. The movers 160 are coupled to the elevator car 110. The movers 160 comprise electromagnetic components 310, such as windings, and, preferably, permanent magnets, for magnetically levitating the movers 160 with relative to the stators 140 of the stator beams 130. The stators 140 may, preferably, be of ferromagnetic material, thus providing suitable magnetic circuit for the electromagnetic engagement between the mover 160 and the stator 140. The electromagnetic components 310 and permanent magnets may be used for moving the elevator car 110 along to stators 140 of the electric linear motor 125 in addition to providing magnetic levitation. In this case, there are two electromagnetic components 310 arranged to the mover 160 by which the magnetic levitation may be controlled so that the mover 160, and, thus the elevator car 110, may be moved towards and away from the landing floor. The electromagnetic components 310 are arranged to opposite sides of the stator arranged to the stator beam 130 between the electromagnetic components 310, such as windings and, optionally, permanent magnets (not shown in FIG. 3 for the sake of readability). There may also be a guiding element 320, such as a roller 320 or a sliding surface or surfaces, arranged to support to movement of the mover 160 with respect to the stator 140, in this case, in the direction perpendicular to the movement towards or away from the landing floor. According to some embodiments of the present invention, the electromagnetic components 310 are arranged to the stator 140 of the electric linear motor 125, as stated hereinabove. Although not shown in FIG. 3 for the sake of readability, the stators 140 are advantageously arranged to face the electromagnetic components 310 of the mover 160 in order to establish the electromagnetic engagement between the stator 140 and the mover 160.

FIG. 4 illustrates schematically an arrangement for controlling a doorstep gap 11 at a landing floor of the elevator 100 according to another embodiment of the present invention. The movers 160 of the electric linear motor 125 are arranged to side walls of the elevator shaft 102. The electromagnetic components 310 are arranged so that the magnetic levitation may be controlled such that the elevator car 110 may be moved towards and/or away from the landing floor in order to regulate the magnitude of the doorstep gap 11. The direction of the movement of the elevator car 110 relative to the stator beam 130 has been indicated by the arrow marked with the reference number 165. There may also be guiding elements 320, such as rollers 320, arranged to support to movement of the mover 160 with respect to the stator 140, in this case, in the direction perpendicular to the movement towards or away from the landing floor. The electromagnetic components 310 are arranged on opposite sides of the stator beam 130 for providing means for moving, while magnetically levitating, the elevator car 110 either towards or away from the landing floor. Although not shown in FIG. 4 for the sake of readability, the stators 140 are advantageously arranged to face the electromagnetic components 310 of the mover 160, for example between said components 310, in order to establish the electromagnetic engagement between the stator 140 and the mover 160.

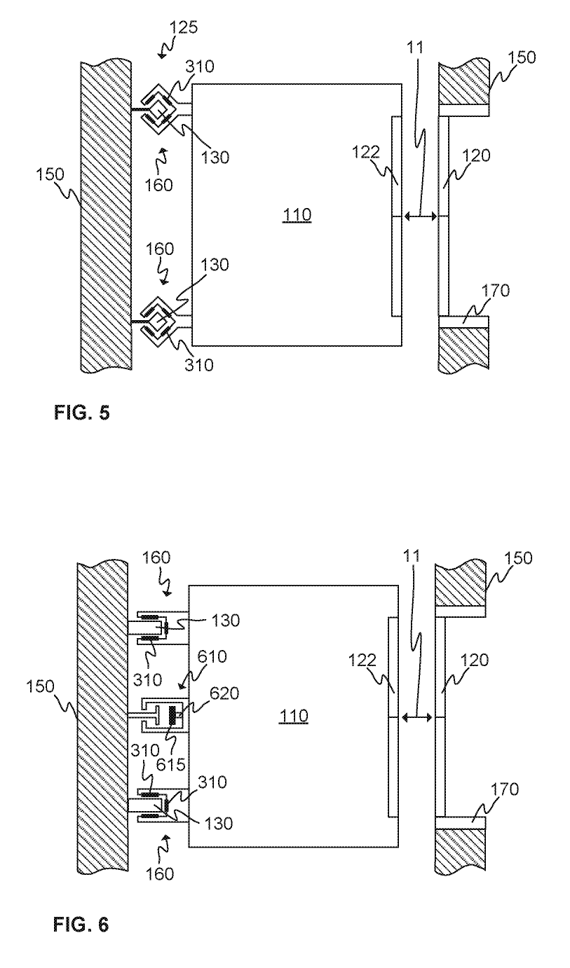

FIG. 5 illustrates schematically an arrangement for controlling a doorstep gap 11 at a landing floor of the elevator 100 according to another embodiment of the present invention. There are two C-shaped movers 160 arranged to be electromagnetic engagement with the stators 140 of the stator beams 130. The stators 140 may preferably be arranged to face the electromagnetic components 310 of the movers 160. The movement of the elevator car 110 may in this embodiment be controlled in other directions as well in addition to moving towards or away from the landing floor by controlling the current injected to the electromagnetic components 310 of the mover 160. Furthermore, the C-shaped movers 160 may be used for preventing the elevator car hitting the landing floor, that is, the doorstep gap 11 from becoming zero. This may be implemented by arranging the elevator car 110 so that a part of the mover 160 comes in contact with stator beam 130 before the elevator car 110 comes in contact with the landing floor when moving the elevator car 110 towards or away from the landing floor. The movers 160 may come into contact with the stator 140 of the stator beam 130 or there may be particularly arranged contact or abutting surfaces or elements, or means of abutting, in the stator beams 130 and/or in the movers 160 for coming into contact with one another.

FIG. 6 illustrates schematically an arrangement for controlling a doorstep gap 11 at a landing floor of the elevator 100 according to another embodiment of the present invention. There are U-shaped movers 160 coupled to the elevator car 110. The movers 110 may comprise electromagnetic components 310 for magnetically levitating the movers 160 with respect to the stators 140. There may also be a guiding rail 610 for guiding the moving of the elevator car 110. The guide rail 610 may be separate from the stator beam 130 or beams 130, and may comprise guiding elements 320, such as, rollers 320, for instance. The guiding rail 610 may extend continuously through whole elevator shaft 102 or may be arranged only at the landing floors for limiting or restricting the moving of the elevator car 110 during magnetic levitation and moving towards or away from the landing floor. The guiding rail 610 may be arranged to prevent the elevator car 110 from coming in contact with the landing floor. It may, however, be arranged to limit the moving in other directions as well. The guiding rail 610 may preferably comprise a first guiding element attached to the elevator shaft 102 and a second guiding element attached to the elevator car 110. There may preferably be specific flanges or contact surfaces, or means of abutting 615, arranged to the guiding rail 610 for coming into contact with one another for limiting the motion of the elevator car 110.

According to some embodiments of the present invention, an elastic element, such as a spring element 620, may be arranged to oppose the movement of the elevator car 110 towards or away from the landing floor, for example, alone, or coupled to a roller of the guide rail 610 or to abutting means 615, for instance. The spring element 620 may preferably be arranged at the landing floor for preventing the elevator car 110 from hitting the landing floor too hard, that is providing cushion, and causing uncomfortable motion for the people inside the elevator car 110, for instance.

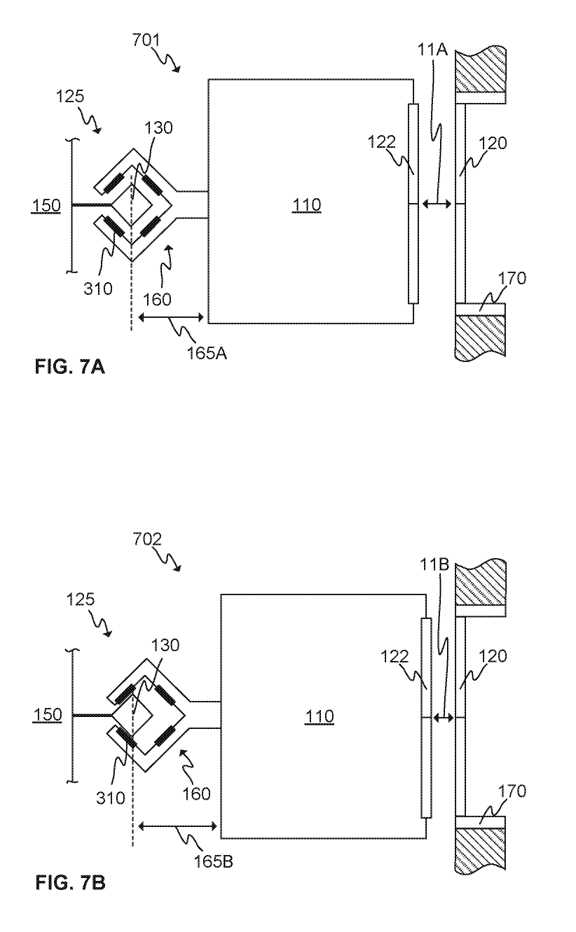

FIGS. 7A and 7B illustrate schematically the moving of the elevator car 110 towards and/or away from the landing floor. The moving towards and/or away from the landing floor is illustrated in FIGS. 7A and 7B in case of an electric linear motor 125, or at least one pair of mover 160 and stator 140, in FIG. 5. As can be seen, the elevator car 110 is in its normal position 701 in FIG. 7A, that is, the stator beam 130 is more or less in the center of the volume defined by the C-shaped mover 160, and there is a first distance 165A between the stator beam 130 and the elevator car 110. In FIG. 7B, by utilizing magnetic levitation and, preferably, by controlling the current injected to the electromagnetic component 310, such as windings, arranged to the mover 160, the elevator car 110 is moved towards the landing floor, that is, to a second position 702 when there is a second distance 165B between the stator beam 130 and the elevator car 110, and the doorstep gap 11 is being reduced. Before or when the elevator car 110 is being moved along the stator beam 130 from the landing floor, the elevator car 110 is configured to be moved from the second position 702 to the first position 701. According to some embodiments, the mover 160 is being arranged to the side of the elevator car 110 and, thus, the elevator car 110 is being moved relative to the stator beam 130 in order to control the magnitude of the doorstep gap 11.

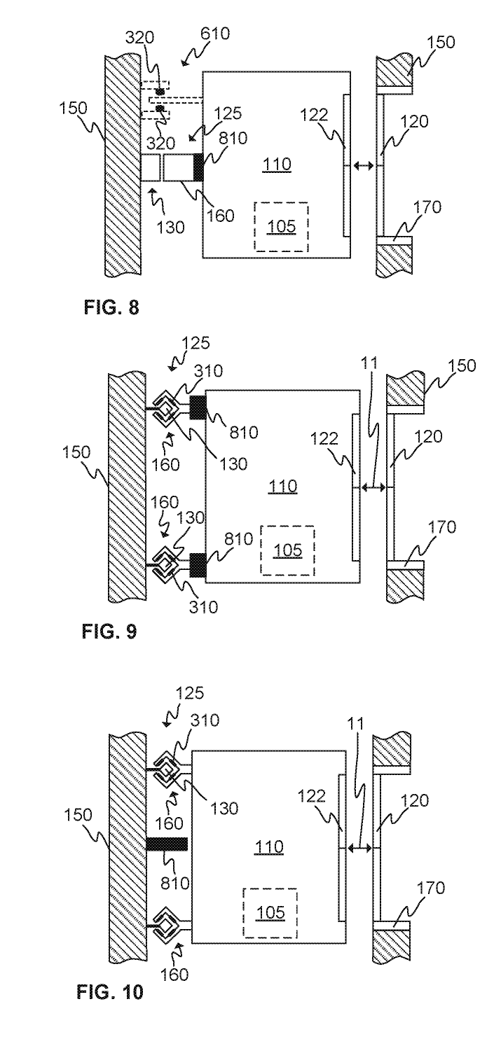

FIG. 8 illustrates schematically an arrangement for controlling a doorstep gap 11 at a landing floor of the elevator 100 according to an embodiment of the present invention. In FIG. 8, displacement means 810 are coupled to the elevator car 110 and configured for moving the elevator car 110 at least towards or away from the landing floor. The displacement means may comprise an actuator being coupled a displacement member such that the elevator car 110 may be moved relative to the stator beam 130. In FIG. 8, particularly, the displacement means 810 are coupled between the mover 160 and the elevator car 110, and, therefore, the mover 160 may be moved relative to the elevator car 110, thus moving the elevator car 110 relative to the stator beam 130, if the elevator 100 is configured such that the mover 160 is controlled to maintain its position with respect to the stator beam 130. The displacement means may further comprise, for example, accelerometers, position sensors, a signal conditioning unit, a processing unit, an energy storage, and power electronics. According to various embodiments, the operation of the displacement means 810 may be controlled by the elevator control unit 1000.

FIG. 9 illustrates schematically an arrangement for controlling a doorstep gap 11 at a landing floor of the elevator 100 according to an embodiment of the present invention. The elevator 100 of FIG. 9 comprises two C-shaped movers 160. Two displacement means 810 have been coupled between the movers 160 and the elevator car 110 for moving the elevator car 110 relatively to the stator beam 130 as described with respect to FIG. 8. According to an embodiment of the present invention, there may be common displacement means 810 for each of the movers 160.

With respect to FIGS. 8 and 9, the displacement means 810 may, according to some embodiments, comprise an active damper. The active damper may be used in normal operation for damping the mechanical vibrations in the elevator 100, such as due to the operation of the electric linear motor 125 or the moving of the elevator car 110. However, the active damper may further be configured to move the elevator car 110 relative to the stator beam 130 for controlling the doorstep gap 11. The active damper may a sensor for generating a sensor signal in response to vibrations affecting the sensor, for example, when arranged to the mover 160. There may also be a controller for receiving the sensor signal and for generating a control signal. Furthermore, the active damper may comprise a damping actuator constructed and arranged to generate a force in response to the control signal to reduce the vibration in the elevator, such as in the mover 160.

FIG. 10 illustrates schematically an arrangement for controlling a doorstep gap 11 at a landing floor of the elevator 100 according to an embodiment of the present invention. The displacement means 810, such as comprising an actuator and a displacement member in connection with the actuator, wherein the displacement member is configured to move, such as at least push, by using the actuator the elevator car 110 towards the landing floor, or the sill thereof. The displacement means 810 in FIG. 10 are coupled to the elevator shaft at least at the landing floor and configured for moving the elevator car 110 at least towards the landing floor, however, may also be configured to move the elevator car 110 away from the landing floor.

Furthermore, it should be noted that the displacement means 810 may be arranged to elevators in which magnetic levitation is being utilized for controlling the lateral movement of the mover 160 with respect to the stator 140 or stators 140, or to elevators 100 in which the magnetic levitation is not being used, but the lateral movement is controlled by other means, such as guiding rails, rollers or sliding surfaces, for instance. Thus, the displacement means 810 shown in and described in connection with FIGS. 8-10 may also be utilized in embodiments illustrated in FIGS. 2-7B.

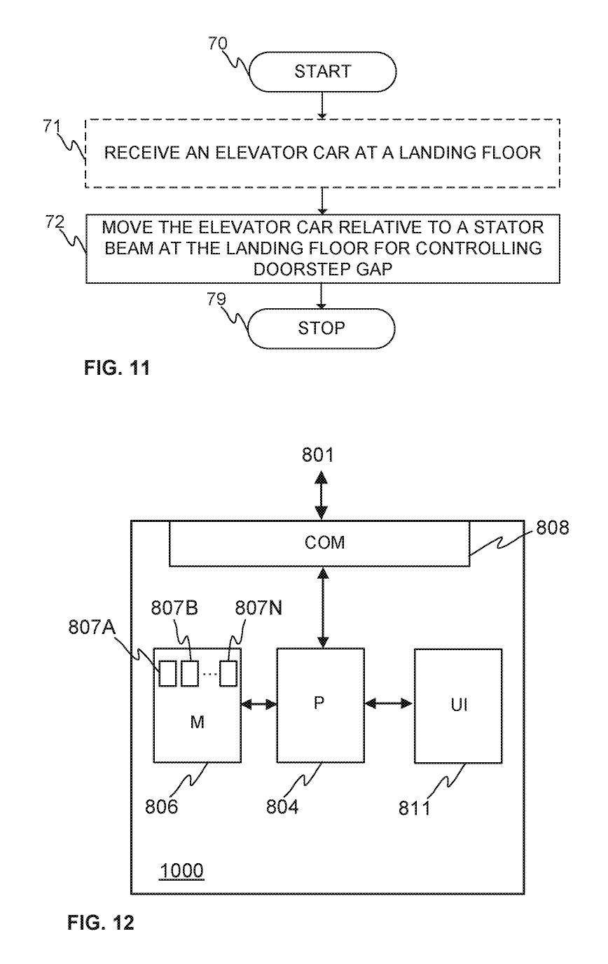

FIG. 11 illustrates a flow diagram of the method according to an embodiment of the present invention. At 70, referring to a start-up phase, the necessary tasks such as obtaining components and systems, and calibration and other configuration may take place. Specific care must be taken that the individual elements and material selections work together. Communication and electrical connections between various components and (sub-)systems may be established.

At 71, which is an optional feature, the elevator car 110 is being received at the landing floor. This may entail moving and, preferably, gradually decelerating the movement of the elevator car 110 in order to stop the movement with respect to the direction along the stator beam 130. The position and movement of the elevator car 110 may be monitored by one or several sensors arranged to the elevator car and elevator shaft 102, for instance. The receiving 71 may entail the elevator car 110 entering the landing floor zone which may start already tens of centimetres before the exact position at which the elevator car 110 is intended to be stopped, or it may entail stopping the elevator car 110 to said exact position with respect to the direction defined by the stator beam 130.

According to various embodiments of the present invention, the elevator car 110 may be configured to be moved towards the landing floor at which it is intended to be stopped at, for example, by moving the elevator car 110 up or down in the elevator shaft 102. The elevator 100 may comprise means for detecting when the elevator car 110 arrives to the landing floor zone. This may be implemented by position sensors, such as, Hall sensors and magnets, arranged to the elevator car 110 and the elevator shaft 102, respectively or vice versa.

Once the elevator car 110 has been stopped at the landing floor with respect to its normal movement direction when serving landing floors and moving along the stator 140 or stators 140, that is, typically up or down, the electric linear motor 125 may be controlled such that the magnetic levitation, if being utilized, is maintained and the elevator car 110 remains in its position by controlling the magnetic levitation appropriately. The elevator car 110 may also be kept in its position with respect to the longitudinal direction of the stator beam 130 by other means such as by brakes.

At 72, moving the elevator car 110 relative to a stator beam 130 of the electric linear motor 125 at the landing floor for controlling the doorstep gap 11 at the landing floor may be performed. However, the moving of the elevator car 110 towards the landing floor may already be started when the elevator car 110 enters the landing floor zone even if the elevator car 110 is still moving in the direction along the stator beam 130, that is, typically in the vertical direction.

According to an embodiment, the moving 72 may be performed by controlling magnetic levitation of the electric linear motor 125 at the landing floor for moving the elevator car 110 at least towards the landing floor, typically in perpendicular direction with respect to the longitudinal direction of the stator beam 130, that is, horizontally, is performed, thus controlling the magnitude of the doorstep gap 11 at the landing floor. This may, preferably, be done by utilizing the electromagnetic components 310 of the electric linear motor 125 which are used at least for magnetically levitating, for example, by controlling a current at least partly establishing the electromagnetic engagement, the mover 160 or movers 160, and thus the elevator car 110, with respect to the stator 140 or stators 140. These components 310 may, preferably, also be used for moving the mover 160 along the stator 140.

The controlling of the magnetic levitation may be implemented by controlling the current injected to the electromagnetic components 310 of the electric linear motor 125. This may be, for example, windings 310 arranged to the mover 160 of the electrical linear motor 125 or windings 310 arranged to the stator 140 of the electric linear motor 125. In case of permanent magnet motor, there may also be permanent magnets arranged to either the mover 160 or the stator 140. The permanent magnets produce static magnetic field and the controllable electromagnetic components 310 may then be controlled to move the mover 160 along the stator 140. Both the stator 140 and the mover 160 may preferably comprise ferromagnetic material to form a magnetic circuit via which the electromagnetic engagement between the stator 140 and the mover 160 is being established. According to some embodiments, the displacement means 810 as described hereinearlier may, alternatively or in addition, be utilized for moving the elevator car 110 towards and/or away from the landing floor.

In order for the mover 160 to be moved along the stator 140, there must be a gap between the two. Depending on the topology and properties, such as shape, of the electric linear motor 125, the mover, when magnetically levitated, may be moved, typically, in horizontal directions or plane to certain amount. For example, as shown in FIG. 2, the mover 160 may be moved away from or towards the stator 140, and thus towards or away from the landing floor, respectively. The distance related to how much the mover 160 can be moved may be limited. This is clearly visible from FIGS. 3-5, for instance, in which the stator 140 or stator beam 130 comes in contact with the mover 160 before the elevator car 110 comes in contact with the landing floor.

In various embodiments of the present invention, the gap between the mover 160 and the stator 140 may be of the order of millimetres to tens of millimetres, such as, ranging from 1-30 millimetres. However, depending on the topology and the structure of the electric linear motor 125, the gap may preferably be from 1 millimetre to about 10 millimetres, and most preferably 1 millimetre to 5 millimetres. The gap together with controlled magnetic levitation may, therefore, be utilized to reduce the doorstep gap 11 at the landing floor. By moving the mover 160, and thus the elevator car 110, towards the landing floor, the doorstep gap 11 may be at least made narrower, if not completely closed. The movement towards the landing floor may be limited or restricted, as stated hereinabove, for example, by the mover 160 coming in contact with the stator beam 130, or by a separate guiding rail 610 as in FIG. 6.

The levitation may be controlled by controlling the current injected to the electromagnetic components 310 of the electric linear motor 125. The force generated by the injected current may “pull” or “push” to elevator car 110 towards the landing floor. The net force affecting the mover 160 may also be obtained by the unbalance between the forces caused by, for example, two electromagnetic components 310 of the mover 160 arranged on opposite sides of the corresponding stator 140. As can be seen in FIG. 5, the magnetic levitation may be controlled by mutually controlling the current injected to more than two electromagnetic components 310, in this case, total of four. This allows moving the elevator car 110 in other directions as well in addition to moving the elevator car 110 towards or away from the landing floor.

There may be position, velocity and/or acceleration sensors arranged to the elevator car 110 in order to monitor the position of the car 110. Measurements from one or several of these sensors may be used as inputs, such as via negative feedback, for the elevator control unit 1000 or system, or a separate control system of the elevator car 110 for controlling the movement of the elevator car towards and away from the landing floor.

The current injected to the electromagnetic component 310 or components 310 may be controlled by known control methods, such as, by vector or scalar control methods. The methods may include cutting off the current from one of the electromagnetic components 310 completely for a short period of time (e.g. average current control) or merely reducing the magnitude of the current.

The elevator car 110 may then be moved back to its normal position with respect to the stator beam 130, that is, moved away from the landing floor before the elevator car 110 is ready to start to serve landing floors in the normal manner. In this case too, the elevator car 110 may be moved simultaneously away from the landing floor with the movement along the stator beam 130 at the landing floor zone.

At 79, the method execution is ended or stopped. The method flow may be executed at least once every time the elevator car 10 is arriving at a landing floor.

FIG. 12 illustrates schematically an elevator control unit 1000 according to an embodiment of the present invention. External units 801 may be connected to a communication interface 808 of the elevator control unit 1000. External unit 801 may comprise wireless connection or a connection by a wired manner. The communication interface 808 provides interface for communication with external units 801 such as the elevator car 110, the electric motor 125, the doors of the landing floors 120, equipment or sensors in the elevator shaft 102 or the electrical drive 105, for example. There may also be a connection to an external system, such as a laptop or a handheld device. There may also be a connection to a database of the elevator 100 or an external database including information used in controlling the operation of the elevator 100.

The elevator control unit 1000 may comprise one or more processors 804, one or more memories 806 being volatile or non-volatile for storing portions of computer program code 807A-807N and any data values and possibly one or more user interface units 811. The mentioned elements may be communicatively coupled to each other with e.g. an internal bus.

The processor 804 of the elevator control unit 1000 is at least configured to implement at least some of the method steps described hereinabove with respect to moving the elevator car at least towards a landing floor. The implementation of the method may be achieved by arranging the processor 804 to execute at least some portion of computer program code 807A-807N stored in the memory 806 causing the processor 804, and thus the elevator control unit 1000, to implement one or more method steps as described. The processor 804 is thus arranged to access the memory 806 and retrieve and store any information therefrom and thereto. For sake of clarity, the processor 804 herein refers to any unit suitable for processing information and control the operation of the elevator control unit 1000, among other tasks. The operations may also be implemented with a microcontroller solution with embedded software. Similarly, the memory 806 is not limited to a certain type of memory only, but any memory type suitable for storing the described pieces of information may be applied in the context of the present invention.

The specific examples provided in the description given above should not be construed as limiting the applicability and/or the interpretation of the appended claims. Lists and groups of examples provided in the description given above are not exhaustive unless otherwise explicitly stated.

1. A method for controlling a doorstep gap at a landing floor of an elevator, the elevator comprising an electric linear motor coupled to an elevator car, wherein the method comprises moving the elevator car relative to a stator beam of the electric linear motor at the landing floor for controlling the doorstep gap at the landing floor.

2. The method according to claim 1, wherein the moving comprises controlling magnetic levitation of the electric linear motor at the landing floor for moving the elevator car at least towards or away from the landing floor.

3. The method according to claim 1, comprising controlling the moving of the elevator car at least towards or away from the landing floor by utilizing an electromagnetic component of the electric linear motor.

4. The method according to claim 2, wherein the electric linear motor comprises a mover in electromagnetic engagement with a stator comprised in the stator beam, and wherein the mover is coupled to the elevator car, and wherein in the method the controlling of said magnetic levitation comprises controlling a current at least partly establishing said electromagnetic engagement.

5. The method according to claim 1, wherein the moving comprises utilizing displacement means configured for moving the elevator car at least towards or away from the landing floor at the landing floor.

6. The method according to claim 5, wherein the displacement means are coupled to the elevator car and configured for moving the elevator car at least towards or away from the landing floor.

7. The method according to claim 5, wherein the electric linear motor comprises a mover in electromagnetic engagement with a stator comprised in the stator beam, and wherein the displacement means comprise an active damper coupled to the mover and configured for moving the elevator car relative to the mover at least towards or away from the landing floor.

8. The method according to claim 5, wherein the displacement means are coupled to the elevator shaft at least at the landing floor and configured for moving the elevator car at least towards or away from the landing floor.

9. The method according to claim 1, comprising limiting the moving of the elevator car towards the landing floor by limiting means for limiting the movement of the elevator car.

10. The method according to claim 1, comprising limiting the moving of the elevator car towards the landing floor by a guiding rail.

11. The method according to claim 1, comprising opposing the moving of the elevator car towards the landing floor by an elastic element.

12. The method according to claim 1, comprising receiving the elevator car at the landing floor.

13. An elevator control unit for controlling a doorstep gap at a landing floor of an elevator, the elevator comprising an electric linear motor coupled to an elevator car, wherein the elevator control unit comprises:
at least one processor, and
at least one memory storing at least one portion of computer program code, and
wherein the at least one processor is configured to cause the elevator control unit at least to perform:
move the elevator car relative to a stator beam of the electric linear motor at the landing floor for controlling the doorstep gap at the landing floor.

14. A computer program product comprising program instructions which when executed by an elevator control unit cause the elevator control unit to perform the method according to claim 1.

15. An elevator for controlling a doorstep gap at a landing floor of an elevator, wherein the elevator comprises an electric linear motor coupled to an elevator car and an elevator control unit configured at least to:
move the elevator car relative to a stator beam of the electric linear motor at the landing floor for controlling the doorstep gap at the landing floor, and
wherein the elevator control unit and the electric linear motor are coupled to each other.
